(19) United States
(12) Patent Application Publication
(10) Pub. No.: US 2026/0249984 A1
(43) Pub. Date: Aug. 27, 2026

(54) SYSTEMS AND METHODS FOR ELECTRIC-POWERED FLIGHT VEHICLES

(71) Applicant: Robert Love, Ramona, CA (US)

(72) Inventor: Robert Love, Ramona, CA (US)

(21) Appl. No.: 18/879,192

(22) PCT Filed: Jun. 28, 2023
(86) PCT No.: PCT/US2023/026402

§ 371 Date: Dec. 26, 2024

Related U.S. Application Data
(60) Provisional application No. 63/367,128, filed on Jun. 28, 2022.

(51) Int. Cl. B64C 25/32; B60L 8/00; B60L 15/20; B60L 50/40; B60L 50/60; B64C 5/06; B64C 7/00; B64C 11/46; B64C 13/18; B64C 25/34; B64C 25/42; B64C 25/50; B64C 39/02; B64D 27/34; B64D 27/353; B64D 27/357; G05D 1/48; G05D 109/22

(52) U.S. Cl. CPC B64C 25/405; B60L 8/003; B60L 15/20; B60L 50/40; B60L 50/60; B64C 5/06; B64C 7/00; B64C 11/46; B64C 13/18; B64C 25/34; B64C 25/42; B64C 25/50; B64C 39/026; B64D 27/34; B64D 27/353; B64D 27/357; G05D 1/48; B60L 2200/10; B60L 2250/26; G05D 2109/22

(57) ABSTRACT

A flight vehicle includes a frame, a propulsion system coupled to the frame, a first source of power coupled to the frame and configured to power the propulsion system, a traction wheel coupled to the frame and configured for tractional engagement with a ground surface during low-speed ground operation of the flight vehicle, and a second source of power coupled to the frame and configured to power to the traction wheel.

### CROSS-REFERENCE TO RELATED APPLICATIONS

This application claims the benefit of, and priority to, U.S. Provisional Patent Application Ser. No. 63/367,128, entitled “FLYING BICYCLE,” filed Jun. 28, 2022, the contents of which are hereby incorporated by reference in their entirety.

### FIELD OF THE DISCLOSURE

The field of the disclosure relates generally to electrically powered flight vehicles and, more particularly, to systems and methods for augmenting an electrically powered flight vehicle during ground operations.

### BACKGROUND

Flight vehicles that use propellers operate under efficiency constraints imposed by propeller blade pitch. For example, an optimal blade pitch for cruise is quite different from an optimal blade pitch for runway acceleration and takeoff. Typical fixed-pitch propellers compromise both cruise and takeoff performance to obtain a blend which only partially decreases the performance of the propeller in each condition. Accordingly, known aircraft with fixed pitch propellers optimized to avoid compromise penalties for cruise flight are unable to accelerate and deaccelerate quickly to takeoff and land in short distances, since the propeller design sacrifices takeoff performance to a larger extent. Variable pitch propellers were designed to correct this problem, but mechanisms to vary propeller pitch are heavy and mechanically complex, imposing their own efficiency penalties, particularly on light-weight flight vehicles. The penalty imposed by a variable pitch propeller is larger when attempting to distribute many propulsors along the span of a wing.

In addition, electrically powered aircraft leverage distributed electric propulsion systems to distribute thrust and fly at much slower forward speeds to minimize a risk of injury to the occupant. Distributed electric propulsion systems can generate higher lift for a given wing area. The smaller wing with higher wing loading can also provide better ride quality.

However, powered-lift aircraft struggle to achieve short landing distances since high thrust must be provided by the propellers during approach.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Disclosed herein are novel embodiments of flight vehicles which include an electric power source, without pedals (like a motorcycle) or with pedals integrated in line with the electric power source (like electric bicycles), that directly drives a wheel of the flight vehicle. The motor can generate high torque at low speeds, causing the wheel, via traction with the ground, to accelerate the flight vehicle quickly and efficiently without relying on low speed thrust from the propellers. Because reliance on the propellers for takeoff thrust is reduced or eliminated, a fixed propeller pitch can be selected for greater efficiency at cruise. In some embodiments, the resulting efficiency gain is in a range of 5-10 percent as compared to fixed-pitch propellers with pitch selected to facilitate both takeoff and cruise.

In addition, disclosed herein are novel embodiments of a control surface implemented by a wheel fairing. The wheel fairing can act as a speed brake which generates drag during an approach to landing or while decelerating on the landing surface, which can significantly shorten a ground area needed for landing. The wheel fairing also reduces wheel drag during ground operations. The wheel fairing control surface can also provide an operator of the flight vehicle with limited manual control authority while an automated flight control system maintains stable flight path control with electric propulsors.

In one aspect, a flight vehicle is provided. The flight vehicle includes a frame, a propulsion system coupled to the frame, a first source of power coupled to the frame and configured to power the propulsion system, a traction wheel coupled to the frame and configured for tractional engagement with a ground surface during low-speed ground operation of the flight vehicle, and a second source of power coupled to the frame and configured to power to the traction wheel.

In another aspect, a flight vehicle is provided. The flight vehicle includes a frame, a propulsion system coupled to the frame, a first source of power coupled to the frame and configured to power the propulsion system, a guidance wheel pivotably coupled to the frame and configured to steer the flight vehicle during ground operations, and a guidance wheel fairing coupled to the frame and at least partially enclosing, and configured to pivot with, the guidance wheel. The guidance wheel fairing is operable as a control surface of the flight vehicle.

In another aspect, a flight vehicle is provided. The flight vehicle includes a frame, a guidance wheel pivotably coupled to the frame, a guidance wheel fairing at least partially enclosing the guidance wheel and configured to pivot, and at least one manual control configured to orient the guidance wheel fairing in response to operation by an on-board human operator of the flight vehicle. The orientation is selectable to set a heading of the flight vehicle during flight. The flight vehicle also includes a plurality of propulsors coupled to the frame, and a controller coupled to the frame. The controller includes at least one processor in communication with a memory and operably coupled to the plurality of propulsors, the memory storing instructions that are executable to cause the processor to automatically maintain the flight vehicle in level flight during flight.

### BRIEF DESCRIPTION OF THE SEVERAL VIEWS OF THE DRAWINGS

A more particular description of the principles briefly described above will be rendered by reference to specific embodiments thereof that are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings.

FIG. 1A illustrates a schematic perspective view of a flight vehicle in accordance with embodiments of the present disclosure.

FIG. 1B illustrates a schematic bottom view of the flight vehicle of FIG. 1A in accordance with embodiments of the present disclosure.

FIG. 1C illustrates a schematic perspective view of the flight vehicle of FIG. 1A showing a fuselage and alternative propulsors in accordance with embodiments of the present disclosure.

FIG. 2A illustrates a schematic block diagram of a power system of the flight vehicle of FIG. 1A in accordance with embodiments of the present disclosure.

FIG. 2B illustrates another schematic block diagram of a power system of the flight vehicle of FIG. 1A in accordance with embodiments of the present disclosure.

FIG. 3 is a table of example control features corresponding to each degree of freedom of the flight vehicle of FIG. 1A in accordance with embodiments of the present disclosure.

FIG. 4 illustrates an example controller data flow that can be used by a controller of the flight vehicle shown in FIG. 1A.

FIG. 5 illustrates a schematic block diagram of a computer system that can be implemented with other aspects of the present disclosure.

### DETAILED DESCRIPTION

Various example embodiments of the disclosure are discussed in detail below. While specific implementations are discussed, it should be understood that this description is for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment. Such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others. Any feature of one example can be integrated with or used with any other feature of any other example.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

For clarity of explanation, in some instances the present technology may be presented as including individual functional blocks representing devices, device components, steps or routines in a method embodied in software, or combinations of hardware and software.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

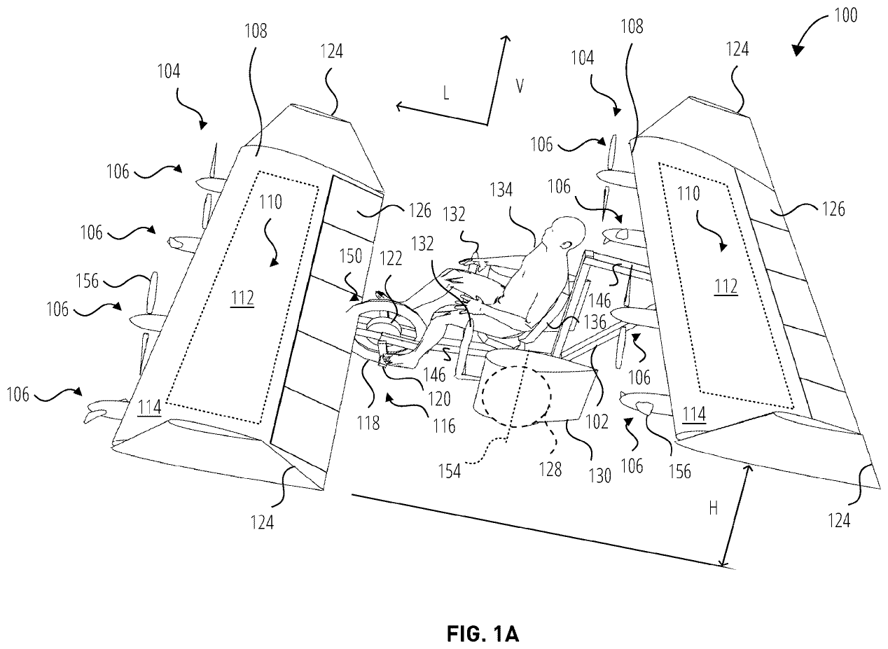

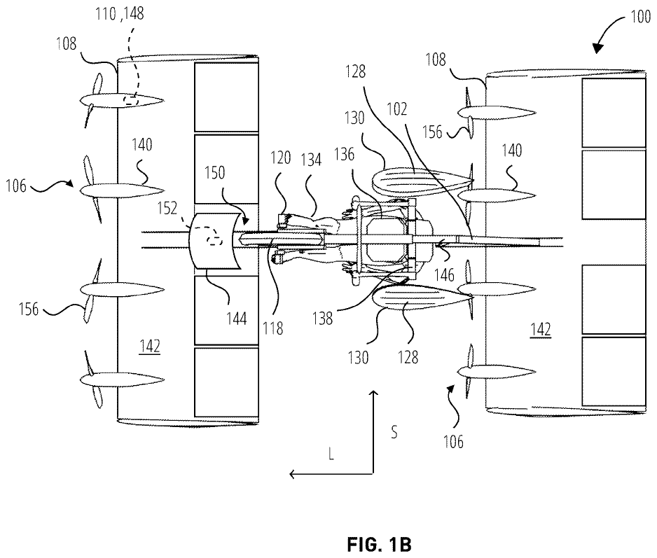

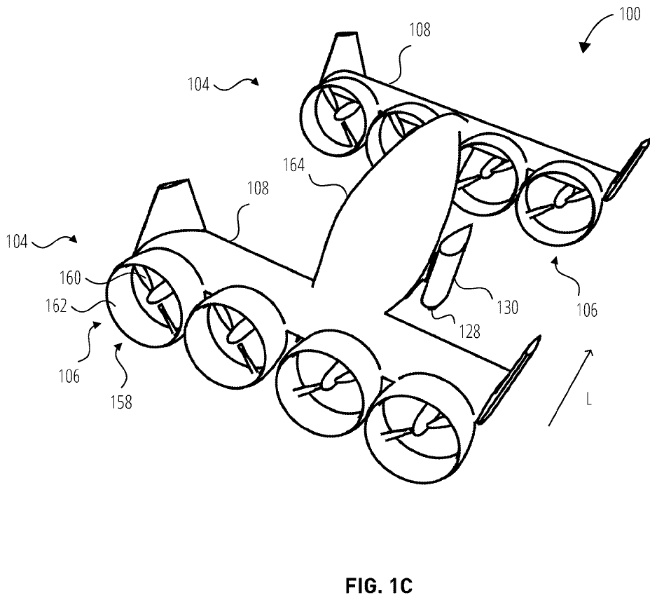

FIG. 1A illustrates a schematic perspective view of an example embodiment of a flight vehicle 100, and FIG. 1B illustrates a bottom view of the flight vehicle 100. In some embodiments, the flight vehicle 100 is an ultralight vehicle. The phrase “ultralight vehicle” means a vehicle that qualifies as such under the United States Code of Federal Regulations, Title 14, Part 103 (“14 CFR Part 103”). For example, to satisfy 14 CFR Part 103 as revised in June 2023, a powered flight vehicle must weigh less than 254 pounds; have a fuel capacity not exceeding 5 U.S. gallons; not be capable of a level flight speed of more than 55 knots; and have a power-off stall speed of no more than 24 knots.

In some embodiments, the flight vehicle 100 satisfies some but not all of the requirements for an ultralight vehicle. For example, but not by way of limitation, exceptions to 14 CFR Part 103 can be obtained for home-built vehicles which weigh less than 254 pounds, have a fuel capacity not exceeding 5 U.S. gallons, and are not capable of a level flight speed of more than 55 knots, but do not satisfy the requirement for a power-off stall speed of no more than 24 knots.

In some embodiments, the flight vehicle 100 is a light-sport aircraft. The phrase “light-sport aircraft” means a vehicle that satisfies the definition of “Light-sport aircraft” provided in the United States Code of Federal Regulations, Title 14, Section 1.1 (“14 CFR 1.1”). For example, to satisfy 14 CFR 1.1 as revised in June 2023, a light-sport aircraft must have a maximum takeoff weight of not more than 1,320 pounds for aircraft not intended for operation on water (or 1,430 pounds for an aircraft intended for operation on water), a maximum airspeed in level flight with maximum continuous power of not more than 120 knots under standard atmospheric conditions at sea level, and a maximum stalling speed or minimum steady flight speed without the use of lift-enhancing devices (VS1) of not more than 45 knots at the aircraft's maximum certificated takeoff weight and most critical center of gravity.

In some embodiments, the flight vehicle 100 satisfies some but not all of the requirements for a light-sport vehicle.

Embodiments of the flight vehicle 100 other than those described in terms of FAA regulations above are also contemplated.

The flight vehicle 100 can include a frame 102 configured to provide structural support for other components of the flight vehicle 100. In some embodiments, the frame 102 is formed substantially from steel. Additionally or alternatively, the frame 102 can include one or more of aluminum or carbon fiber-reinforced composite materials. However, other materials for the frame 102 are also contemplated. In the illustrated embodiment, the frame includes a plurality of elongated members 146 affixed together. In some embodiments, the elongated members 146 may be extended to accommodate riders of different heights. Other constructions for the frame 102 are also contemplated.

The flight vehicle 100 can also include at least one wing 108 coupled to the frame 102. In some embodiments, the at least one wing 108 includes two wings 108, with each wing defined as extending from both sides of the frame 102 along a span dimension S of the flight vehicle. (In other words, “two wings” does not simply indicate a single left wing paired with a single right wing.) For example, the illustrated embodiment, the two wings 108 are a forward wing 108 and an aft wing 108, with the terms “forward” and “aft” defined in respect to a longitudinal dimension L of the flight vehicle. In some embodiments, the use of two wings 108, in combination with a distribution of propulsors 106 along a span dimension S of both wings as will be discussed subsequently, facilitates achieving a required lift performance with a width of the flight vehicle along the span dimension being substantially decreased relative to a width of known ultralight or similar vehicles. For example, known ultralight vehicles typically have widths of 17 feet or more. In contrast, embodiments of the flight vehicle 100 having forward and aft wings 108 can have a width along the span dimension that does not exceed 12 feet, which advantageously enables the flight vehicle 100 to be accommodated in a 12-foot-wide highway lane or on a trailer built for use in such lanes. Moreover, in some such embodiments, the flight vehicle 100 having two wings 108 can have a width along the span dimension that does not exceed 9 feet, which advantageously enables the flight vehicle 100 to be readily accommodated in a 10-foot-wide highway lane or on a trailer built for use in such lanes. Additionally or alternatively, the forward wing 108 can include a slot 150 defined therein to accommodate a portion of the traction wheel 118 therein in a clearance fit, which advantageously enables a reduced length of the flight vehicle 100 along the longitudinal dimension L (by allowing a longitudinal length of the forward wing 108 to overlap a position of the traction wheel 118). In some embodiments, the forward wing 108 can be located low to the ground (for example, a ratio of a height of the forward wing 108 from the ground to a chord length of the forward wing 108 can be less than 0.5), which tends to maximize ground effect. The term “ground effect” refers to a reduction in aerodynamic drag generated by a fixed wing when the wing is in proximity to a fixed ground surface. An increase in ground effect correspondingly reduces takeoff distance, and also reduces friction forces during ground operations, which maximizes range during ground operations. Other numbers and arrangements of the at least one wing 108 are also contemplated.

In some embodiments, the at least one wing 108 can be formed from, for example, Dacron wing skins over a wing box formed from steel or aluminum. However, other materials for the at least one wing 108 are also contemplated.

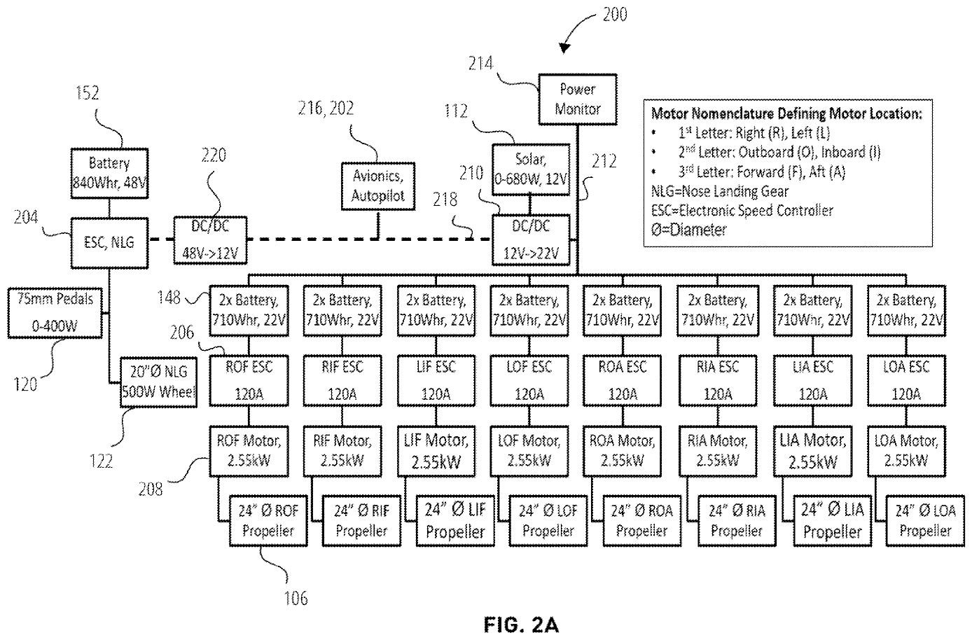

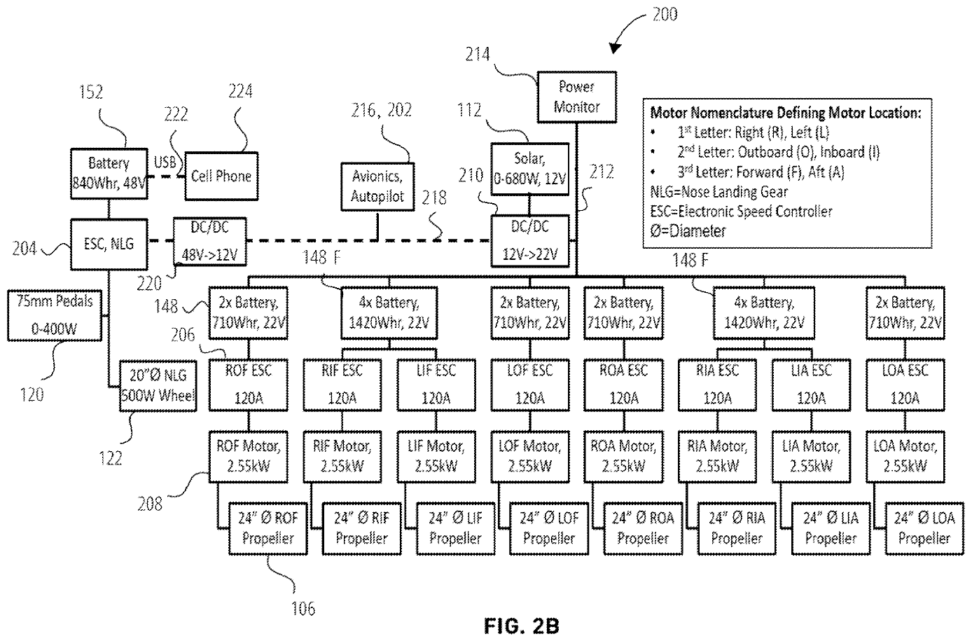

The at least one wing 108 can include additional features that facilitate an improved stability of the flight vehicle 100. For example, in the illustrated embodiment, that at least one wing 108 includes rigid winglets 124 extending along a vertical dimension V from opposing tips of the wing. Additionally or alternatively, the at least one wing 108 can include one or more control flaps 126 that are actuatable for stability or guidance, either manually by a human operator 134 or automatically by on-board avionics package 216 (shown in FIG. 2A). Other implementations of stability and guidance features are also contemplated. For example, but not by way of limitation, the flight vehicle 100 can include circulation-control features (such as wing gaps or micro-compressors, not shown) to prevent or reduce flow separation over the wings 108 or fuselage 164, thereby improving a coefficient of lift at high angles of attack or otherwise.

The flight vehicle 100 can also include a propulsion system 104 coupled to the frame 102 and configured to power the flight vehicle 100 in flight. In the illustrated embodiment, the propulsion system 104 is coupled to the frame 102 indirectly via mounting the propulsion system on the at least one wing 108. For example, the propulsion system 104 can include one or more propulsors 106, and each propulsor 106 can be housed in a nacelle 140 that is affixed to a bottom surface 142 of the at least one wing 108. However, other implementations of coupling the propulsion system 104 to the frame 102 are also contemplated.

In some embodiments, the propulsion system 104 includes a plurality of propulsors 106. For example, as noted above, the propulsors 106 can be distributed along the span dimension S of each wing 108 to improve a lift performance of the flight vehicle 100. In the illustrated embodiment, each propulsor 106 is implemented as a fixed-pitch propeller 156, which avoids weight and complexity penalties of variable-pitch propellers as discussed above. However, other implementations of the propulsors 106 are also contemplated. For example, as shown in another example embodiment of the flight vehicle 100 in FIG. 1C, the propulsors 106 can be implemented as ducted fans 158, in which each propulsor 106 includes a fan 160 surrounded by a duct 162 to improve efficiency. Additionally or alternatively, the propulsors 106 can each include a stator (not shown) positioned behind the propeller or fan. These types of propulsors 106 are heavier than the fixed-pitch propellers 156 and may be used, for example, in light-sport aircraft implementations of the flight vehicle 100. However, these examples of propulsor types and aircraft use cases are not intended to be limiting.

In some embodiments, the propulsors 106 are electrically driven. The use of electrically driven propulsors 106 can enable a reduced weight, noise, and complexity of the flight vehicle 100 relative to, for example, internal combustion-type engines. However, other implementations of the propulsors 106 are also contemplated.

The flight vehicle 100 can also include a first source 110 of power coupled to the frame 102 and configured to power the propulsion system 104. For example, the first source 110 can include one or more propulsion batteries 148 configured to power the propulsion system 104. In some embodiments, the propulsion batteries 148 are distributed along the at least one wing 108, which improves a redundancy and reliability of the first source 110 and can reduce wing structural weight. For example, in the illustrated embodiment, at least one propulsion battery 148 is located in each nacelle 140. (Although only one propulsion battery location is illustrated in FIG. 1B for purposes of clarity, it should be understood that the other nacelles 140 or the fuselage 164 can also house propulsion batteries 148.) Other numbers or locations of the propulsion batteries 148 are also contemplated, one example of which is shown in FIG. 2B (discussed below).

Additionally or alternatively, the first source 110 can include one or more solar panels 112 configured to power the propulsion system 104. For example, the one or more solar panels 112 can be positioned on a top surface 114 of the at least one wing 108 to facilitate sunlight exposure during flight, and can be used to charge the propulsion batteries 148. In the illustrated embodiment, the top surfaces 114 of both the forward and aft wings 108 include solar panels 112. However, other numbers and locations of solar panels 112 are also contemplated.

Additionally or alternatively, the first source 110 can include a combination of an internal combustion engine and electrical generator, sometimes referred to as a genset (not shown), or a fuel cell (not shown). For example, the genset or fuel cell can be located within an electronics enclosure 144, and can be connected to the propulsor electric motors 208 or configured to charge the propulsion batteries 148. The genset can be geared or non-geared, and can be of a cylinder-piston or turbomachinery type, for example.

Additionally or alternatively, the flight vehicle 100 can include adapter plugs for charging the propulsion batteries 148 from a ground-based charging station.

Additional or alternative implementations of the first source 110 are also contemplated.

The flight vehicle 100 also includes traction wheel 118 coupled to the frame 102 and configured for tractional engagement with a ground surface during low-speed ground operation of the flight vehicle. The phrase “tractional engagement with the ground surface” means that, during powered rotation of the traction wheel along the ground surface during low-speed ground operation, friction between an outer surface of the traction wheel and the ground surface is sufficient to move the flight vehicle. The “low-speed ground operation” occurs while the flight vehicle is operating on the ground at a speed between zero and a traction-loss speed, at which lift generated by the moving flight vehicle counteracts the weight of the flight vehicle to an extent that the frictional force between the outer surface of the traction wheel and the ground surface no longer creates traction. In some embodiments, the traction-loss speed can be greater than or equal to 20 miles per hour (mph). Moreover, in some such embodiments, the traction-loss speed can be greater than or equal to 28 mph. However, other traction-loss speeds are also contemplated.

The flight vehicle 100 can also include a second source 116 of power coupled to the frame 102 and configured to power to the traction wheel 118. For example, during takeoff of the flight vehicle 100, the traction wheel can be driven by the second source 116 to accelerate the flight vehicle from zero speed, through a relatively low-speed range at which the propulsion system 104 is inoperable or ineffective (for example, due to stall conditions for the propulsors 106 implemented as fixed-pitch propellers 156), to a speed at which the propulsion system 104 becomes efficient for powering the flight vehicle. In other words, in the non-limiting case of the flight vehicle 100 with a fixed-pitch propeller 156, the tractional engagement of the traction wheel 118 with the ground surface enables the flight vehicle to accelerate to a speed at which the fixed-pitch propeller 156 no longer stalls, and the propulsion system 104 can then contribute to the flight vehicle 100 reaching or continuing at flight speed. Because the propulsion system 104 is not required to accelerate the flight vehicle 100 during the low-speed ground operation, the propulsion system 104 can be tuned to operate more efficiently at cruising speeds.

For example, a pitch of the fixed-pitch propellers 156 can be selected for improved efficiency at cruise speed. For another example, a chemistry design of the propulsion batteries 148 can be selected to provide high specific energy, which increases a cruise range of the flight vehicle 100. For another example, a chemistry design of the propulsion batteries 148 can be selected to provide high specific power, which saves weight and improves takeoff performance. As a non-limiting example, conventional fixed-pitch propellers used for both takeoff and cruise typically have a pitch in a range of 10 to 12 inches, while the propulsors 106 of the present disclosure can be implemented as fixed-pitch propellers 156 with a pitch of at least 15 inches to improve cruise performance, since takeoff thrust is supplied or augmented by the traction wheel 118. In some embodiments, the propulsors 106 of the present disclosure implemented as fixed-pitch propellers 156 with a pitch of about 18 inches is particularly advantageous for cruise performance.

Moreover, as compared to conventional flight vehicles in which the propulsion system must be tuned to power all phases of takeoff and cruise, the flight vehicle 100 of the present disclosure enables takeoff from a much shorter runway. For example, the traction wheel can accelerate the flight vehicle to 20 mph over a much shorter runway distance than can a fixed-pitch propulsion system tuned to operate both at speeds below 20 mph and at cruise speed. In addition, the flight vehicle 100 of the present disclosure achieves these advantages without the weight, operational cost, or complexity penalties associated with variable-pitch propellers.

In some embodiments, the second source 116 can include a pedal set 120 coupled to the frame 102 and configured for operation by a human operator 134 on-board the flight vehicle 100 to drive the traction wheel 118. In other words, the human operator 134 can pedal the pedal set 120 to apply power directly to the traction wheel 118. For example, strenuous human pedaling can produce a power level of about 400 watts.

Additionally or alternatively, the second source 116 can include a traction motor 122 configured to drive the traction wheel 118, similar to an electric bicycle. In the illustrated embodiment, the traction motor 122 is mounted directly on the traction wheel 118. However, other mounting arrangements for the traction motor 122 are also contemplated. As a non-limiting example, the traction motor 122 can be implemented as a mid-drive bicycle motor arrangement (not shown), located for example under a seat 136 for the operator, and can include a chain and gear arrangement (not shown) to facilitate speed regulation. In some embodiments, the traction motor 122 is implemented as a 500 watt traction motor. It has been determined that embodiments of the flight vehicle 100 of the present disclosure can achieve takeoff speed under a combined power applied to the traction wheel 118 of about 250 watts from the human operator 134 vigorously pedaling the pedal set 120, plus the power provided by the 500 watt traction motor 122, even with zero thrust contribution from the propulsion system 104. However, other sizes for the traction motor 122 are also contemplated. For example, the traction motor 122 implemented as a 750 watt motor may alleviate reliance on pedaling without incurring too much added weight. In some embodiments, ground operations at speeds up to 28 mph are more efficient using the traction motor 122 as compared to flight vehicles without the traction wheel, while still benefiting from a reduced overall vehicle weight due to, for example, a corresponding reduction in wing span.

Although the flight vehicle 100 can achieve takeoff speeds in at least some conditions without any thrust contribution from the propulsion system 104, it should be noted that, even using a fixed-pitch propeller 156 optimized for cruise speeds, the propulsion system 104 can be used in some cases to contribute to takeoff thrust.

In some embodiments, the second source 116 can include one or more traction batteries 152 configured to supply power to the traction motor 122. For example, the one or more traction batteries 152 can be housed within an electronics enclosure 144 mounted to the frame 102 forward, relative to longitudinal dimension L, of the traction wheel 118. However, other locations or mounting arrangements are contemplated. Alternatively, one or more of the traction batteries 152 can be implemented as traction capacitors. For example, the traction capacitor can discharge to power the traction motor 122 during a takeoff phase of the flight vehicle 100. Other methods for powering the traction motor 122 are also contemplated.

In some embodiments, both the traction battery 152 and the propulsion batteries 148 can have a chemistry that prioritizes high mass-specific energy, in order to improve a range of the flight vehicle 100 both in ground operations, in which the flight vehicle 100 can function as an electric bicycle using the traction battery, and in flight operations. Alternatively, the traction battery 152 can have a chemistry that prioritizes high mass-specific power (to decrease reliance on the propulsion system 104 during takeoff) while the propulsion batteries 148 can have a chemistry that prioritizes mass-specific energy, in order to maximize cruise range. Alternatively again, both the traction battery 152 and the propulsion batteries 148 can have a chemistry that prioritizes high mass-specific power, in order to prioritize super-short takeoff and landing (super-STOL) ability. Alternatively again, the traction battery 152 can have a chemistry that prioritizes high mass-specific energy while the propulsion batteries 148 can have a chemistry that prioritizes mass-specific power, for applications in which the flight vehicle 100 is used primarily for short “hop” flights and extended ground operations. Other tradeoffs between the competing demands to emphasize specific power versus specific energy in the energy sources for either or both of the first source 110 and the second source 116 are also contemplated. In each alternative, a design of the traction motor 122, propulsor electric motors 208, a traction motor ESC 204 (discussed in more detail below), and a propulsor ESCs 206 (also discussed in more detail below) can be selected to match the corresponding battery chemistries.

The flight vehicle 100 can further include a guidance wheel 128 pivotably coupled to the frame 102 and configured to steer the flight vehicle 100 during ground operations. More specifically, the guidance wheel 128 can be pivoted about an axis 154 that extends at least partially in the vertical dimension V, which correspondingly alters a ground path of the flight vehicle 100 during ground operations. For example, the flight vehicle 100 can include at least one manual control 132 configured to manually orient the guidance wheel in response to manual operation by the on-board human operator 134. The manual control 132 can be coupled to the guidance wheel 128 via a suitable manual control linkage 138 that translates movement of the manual control 132 into pivoting of the guidance wheel 128. For example, the manual control 132 can be implemented similarly to a push rod used to steer a rear wheel of a recumbent bicycle.

In the illustrated embodiment, the flight vehicle 100 includes first and second guidance wheels 128 positioned aft of the traction wheel 118 and on opposite sides of the frame 102 with respect to the span dimension S. Each of the first and second guidance wheels 128 is linked to a corresponding manual control 132. Accordingly, the traction wheel 118 and the first and second guidance wheels 128 cooperate to enable the flight vehicle 100 to operate as a ground-based cycle on the ground surface. In some embodiments, the two rear guidance wheels 128, the corresponding manual controls 132 and manual control linkage 138, the seat 136, and a portion of the frame 102 connecting them can advantageously be implemented by incorporating a recumbent bicycle into the flight vehicle 100, and swapping out a front wheel of the recumbent bicycle with the traction wheel 118 including the traction motor 122 mounted thereon. Other arrangements and implementations of one or more guidance wheels 128 are also contemplated.

The flight vehicle 100 can also include a guidance wheel fairing 130 coupled to the frame 102 and at least partially enclosing the guidance wheel 128. In some embodiments, the guidance wheel fairing 130 is configured to pivot about the axis 154 and can be operable as a control surface of the flight vehicle 100. For example, the guidance wheel fairing 130 can define an airfoil profile with a local airfoil span extending at least partially in the vertical dimension V, causing the guidance wheel fairing 130 to behave as a vertical control surface. It should be noted that the axis 154 “extending at least partially in the vertical dimension V” includes the axis 154 oriented diagonally in a plane defined by the vertical dimension V and the span dimension S. In other words, two opposite diagonally oriented guidance wheel fairings 130 can cooperate to define a V-shaped control surface that provides the vertical control surface, as well as a horizontal control surface.

In some embodiments, the same manual control 132 that enables manual orientation of the guidance wheel 128 to steer the flight vehicle 100 during low-speed ground operation can also enable manual orientation of the guidance wheel fairing 130 to set a heading of the flight vehicle 100 during flight. For example, each guidance wheel fairing 130 can be configured to pivot with a corresponding guidance wheel 128, and the at least one manual control 132 configured to orient the guidance wheel 128 to steer the flight vehicle during low-speed ground operation also is manually operable to change a heading of the flight vehicle 100 during flight. In other words, the manual control 132 can be used to pivot the guidance wheel fairing 130 (along with the guidance wheel 128 at least partially enclosed within) about the axis 154 that extends at least partially in the vertical dimension V, and an airflow around the pivoted guidance wheel fairing 130 causes the flight vehicle to yaw, altering the heading of the flight vehicle 100. Other mechanisms for pivoting the guidance wheel fairing 130, such as but not limited to a separately implemented manual control, are also contemplated. For example, independent control of the guidance wheel fairings 130 relative to the guidance wheels 128 can be utilized to enable pivoting of the guidance wheel fairings 130 into a drag-inducing position for use as speed brakes for deceleration on a landing strip, while the guidance wheels 128 themselves are maintained in a straight-ahead orientation to steer the flight vehicle 100 on the landing strip. Alternatively, the guidance wheel fairing 130 can be configured to lock in place during ground operations, while enabling the guidance wheel 128 to pivot within.

In embodiments where more than one guidance wheel 128 is used, the flight vehicle 100 can include a respective guidance wheel fairing 130 that at least partially encloses, and is configured to pivot with, a corresponding one of the guidance wheels 128. For example, where first and second guidance wheels 128 are positioned on opposite sides of the frame 102 with respect to the span dimension S, the respective guidance wheel fairings 130 can each be operable as control surfaces. The use of the guidance wheel fairings 130 can enable stability, guidance and control of the flight vehicle 100 to be achieved even where, as illustrated, the flight vehicle 100 includes no actuatable vertical control surfaces apart from the first and second guidance wheel fairings 130.

In some embodiments, the guidance wheel fairing 130 can be pivotable about the axis 154 independently from any pivoting capability (or lack thereof) of the guidance wheel 128. For example, an orientation of the guidance wheel 128 about the axis 154 can be fixed relative to the frame 102 (that is, non-pivotable), and the manual control 132 can be configured to pivot the guidance wheel fairing 130 about the axis 154 while the guidance wheel 128 remains fixed. Other implementations of the pivoting of each guidance wheel fairing 130 relative to either or both of the frame 102 and the corresponding guidance wheel 128 are also contemplated.

Alternatively, the guidance wheel fairing 130 can be fixed relative to the frame 102 (that is, non-pivotable), and can be sized to accommodate pivoting of the enclosed guidance wheel 128 within the airfoil shape of the guidance wheel fairing 130. In any of the above embodiments or otherwise, the guidance wheel fairing 130 can include an independently actuatable control flap (not shown) at an aft portion thereof to provide additional controllability.

In some embodiments, the first and second guidance wheel fairings 130 are further operable to induce a drag force to decelerate the flight vehicle 100 into a controlled glide path during descent from flight towards ground. The guidance wheel fairings 130 can be pivotable independently from each other to enable deployment in opposite directions, for example to create a symmetric drag force. For example, the first and second guidance wheel fairings 130 can be pivoted outward in opposite directions about the axis 154 90 degrees from the position shown in FIG. 1A, presenting an obstruction to airflow that induces significant drag and thereby reduces airspeed. Although 90 degrees is used as an example, drag-inducing pivots of less than 90 degrees are also contemplated. Although the axis 154 is illustrated as extending substantially along the vertical dimension V, an effective amount of drag can also be produced for orientations of the axis 154 that extend only partially in the vertical dimension. In addition, the first and second guidance wheel fairings 130 can further be operable in a similar fashion to decelerate the flight vehicle 100 after landing from flight, that is, on the ground after landing. Accordingly, the guidance wheel fairings 130 can advantageously facilitate reducing a length of a ground path required to land the flight vehicle 100.

Notably, the advantages of using the guidance wheel fairing 130 as control or drag-inducing surface can be obtained even in embodiments which do not include the powered traction wheel 118. For example, rather than the traction wheel 118 as described herein, the flight vehicle 100 can instead include a simple front wheel and still benefit from the guidance wheel fairing 130 as described herein. The present disclosure contemplates such uses of the guidance wheel fairing 130 independent from the traction wheel 118.

The guidance wheel fairing 130 can also augment steering traction forces during ground operations of the flight vehicle 100. For example, when the human operator 134 pivots the guidance wheels 128 to cause a right turn, aerodynamic forces on the guidance wheel fairing 130 create a yaw force that pulls the flight vehicle 100 toward the desired right turn.

In some embodiments, the traction wheel 118 is further configured to provide a braking force to the flight vehicle 100 during landing, which also can advantageously facilitate reducing a length of a ground path required to land the flight vehicle 100. Moreover, the traction motor 122 can further be configured for regenerative charging. In response to activation of braking, or more generally to the flight vehicle 100 slowing down on the landing path, the traction motor 122 can switch to a regeneration mode in which the motor reverses spin and becomes a generator that converts momentum into electricity. The electricity can be used to recharge, for example, the traction battery 152 (or traction capacitor), or the one or more propulsion batteries 148. Embodiments in which braking or regenerative charging are provided by one or more of the guidance wheels 128 are also contemplated.

As illustrated in FIG. 1C, the flight vehicle 100 can also include a fuselage 164 coupled to the frame 102 and contoured to define an aerodynamic profile of the flight vehicle 100 along the longitudinal dimension L. For example, the fuselage 164 can enclose one or more of the human operator 134, the seat 136, the pedal set 120, the manual controls 132, and some or all elements of the frame 102 to reduce a drag force that would be induced by the less aerodynamic contours of these elements.

FIG. 2A illustrates a schematic block diagram of an example embodiment of a power system 200 of the flight vehicle 100. The power system 200 includes, for example, the one or more solar panels 112, the pedal set 120, the traction motor 122, the one or more propulsion batteries 148, and the traction battery 152 (or traction capacitor).

The power system 200 can also include a traction motor electronic speed controller (ESC) 204 coupled between the traction battery 152 and the traction motor 122. For example, the traction motor ESC 204 can be housed with or integrated with the traction motor 122. Additional or alternative power system components associated with the traction motor 122 are also contemplated.

The power system 200 can further include a propulsor ESC 206 and a propulsor electric motor 208 coupled between each propulsor 106 and the one or more propulsion batteries 148. For example, the propulsor ESC 206 and the propulsor electric motor 208 can be housed in the nacelle 140 corresponding to the propulsor 106. Additional or alternative power system components associated with the propulsors 106 are also contemplated.

The power system 200 can also include a propulsion system power bus 212 that couples the solar panels 112 to the propulsion batteries 148, enabling the solar panels 112 to charge the propulsion batteries 148. The power system 200 can further include a solar panel converter 210 that converts a direct current (DC) voltage provided by the solar panels 112 to a DC voltage of the propulsion batteries 148. Other implementations of the propulsion system power bus 212 are also contemplated.

In some embodiments, the power system 200 can include a traction wheel power bus link 218 that couples the second source 116 of power associated with the traction wheel 118 (for example, one or more of the traction battery 152, the traction motor 122, or the pedal set 120) to the propulsion system power bus 212. In this arrangement, the second source 116 can also be used to charge the first source 110 of power (for example, the propulsion batteries 148), or vice versa. The power system 200 can further include a traction wheel converter 220 that converts a direct current (DC) voltage provided by the second source 116 to a DC voltage output by the solar panels 112 (which enables the traction wheel power bus link 218 to be connected through the solar panel converter 210) or to a DC voltage of the propulsion system power bus 212 for a direct coupling. The power system 200 can also include a bus power monitor 214 and an avionics package 216 configured to automatically implement and control cross-charging between the first source 110 and the second source 116.

FIG. 2B illustrates a schematic block diagram of another example embodiment of the power system 200 of the flight vehicle 100. The power system 200 illustrated in FIG. 2B can include the same or similar elements as described above, but the propulsion batteries 148 for the right and left inboard motors on both the forward and aft wings 108, designated here as 148F, can be housed in the fuselage, rather than in the nacelles 140 of the propulsors 106. Other arrangements of the propulsion batteries 148 and other components of the power system 200 are also contemplated.

In addition, the power system 200 can include a USB port 222 to enable charging and, optionally, other interface connectivity with a cellular phone 224 of the on-board human operator 134. Other types of ports are also contemplated.

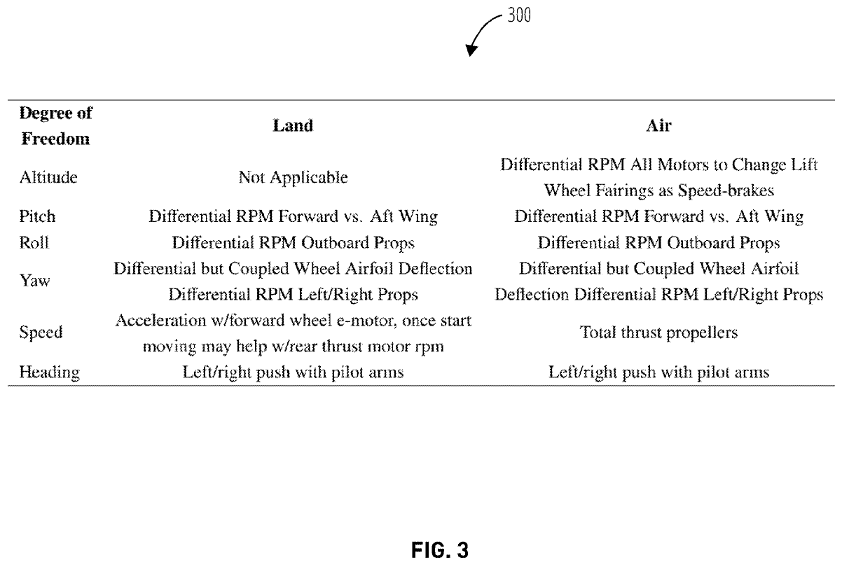

FIG. 3 is a table 300 of example control features corresponding to each degree of freedom of the flight vehicle 100. The control features can include the guidance wheel fairings 130 operable by the human operator 134 to adjust a heading of the flight vehicle 100, as discussed above. The control features can also include a throttle (not shown) operable by the on-board human operator 134 to adjust altitude in flight by adjusting a motor speed across all propulsors 106, which is represented in Table 3 by “Differential RPM All Motors,” as well as the pedal set 120 and traction motor 122 to adjust a speed of the flight vehicle 100 during ground operations, takeoff, and landing.

The control features can also include varying speed control inputs to the propulsor ESCs 206 of the distributed propulsors 106 to control movement of the flight vehicle 100 in certain degrees of freedom. In certain embodiments, the avionics package 216 includes a controller 202 configured to autopilot the flight vehicle 100 within certain degrees of freedom by using differential speed control inputs to the propulsor ESCs 206, while accommodating manual control of some aspects of flight by the on-board human operator 134. For example, the controller 202 can be programmed to automatically maintain the flight vehicle 100 in level flight during a cruise phase, while accommodating altitude adjustments by the human operator 134 using the throttle.

More specifically, the controller 202 can be programmed to automatically maintain a current altitude by automatically altering the speed of all the propulsor electric motors 208 to increase or decrease lift on the flight vehicle 100 in response to altitude perturbations. The controller 202 can also be programmed to detect a desire of the human operator 134 to increase or decrease the altitude by detecting manual adjustments to the throttle, and in response can shift to controlling the motor speed to prevent the altitude from increasing or decreasing too rapidly. The controller can return to autopiloting the altitude in response to detecting that the throttle remains at a set point. The controller can also be programmed to detect a desire of the human operator 134 to decrease the altitude (for example, to initiate landing or change a desired glide path for landing) by sensing that the manual controls 132 are being used to deploy the guidance wheel fairings 130 in a drag-inducing position, and in response can shift to controlling the motor speed to prevent the altitude from decreasing too rapidly during descent. In other words, the controller can shift to limited autopilot control that accommodates the manual control actions of the human operator 134 while maintaining the flight vehicle 100 in a safe envelope of dynamic stability.

Additionally or alternatively, the controller 202 can be programmed to implement pitch control using two or more of the plurality of propulsors 106 that are distributed along the vertical dimension V of the flight vehicle. More specifically, the controller can automatically reduce pitch perturbations by commanding differential thrust from the two or more propulsors 106 distributed along the vertical dimension. For example, in the illustrated embodiment, the aft wing 108 is located above the forward wing 108 by a height H along the vertical dimension V, and the controller can vary the motor speed of the four propulsors 106 on the forward wing relative to the motor speed of the four propulsors 106 on the aft wing to control a pitch orientation of the flight vehicle 100.

Additionally or alternatively, the controller 202 can be programmed to implement yaw control using two or more of the plurality of propulsors 106 that are distributed along the span dimension S of the flight vehicle. More specifically, the controller can automatically reduce yaw perturbations by commanding differential thrust from the two or more propulsors 106 distributed along the span dimension. For example, in the illustrated embodiment, the four propulsors on each wing 108 are distributed along the span of the wing, and the controller can vary the motor speed of the propulsors 106 on the right side of the wing relative to the motor speed of the propulsors 106 on the left side of the wing to control a yaw orientation of the flight vehicle 100. The controller can also be programmed to detect a desire of the human operator 134 to change heading by sensing, for example, when the manual controls 132 are being used to deploy the guidance wheel fairings 130 in a yaw-inducing position, and in response can shift to controlling the motor speed to prevent the yaw from changing too rapidly while the guidance wheel fairings 130 are so deployed. In response to the manual controls 132 returning to a non yaw-inducing position, the controller 202 can detect that the desired new heading has been established and can shift back to automatic controlling against yaw perturbations. In other words, the controller can shift to limited autopilot control that accommodates the manual control actions of the human operator 134 while maintaining the flight vehicle 100 in a safe envelope of dynamic stability.

Additionally or alternatively, the controller 202 can be programmed to implement roll control using two or more of the plurality of propulsors 106 that are located in outboard positions on opposing sides of the frame 102 along the span dimension S. More specifically, the controller can automatically reduce roll perturbations by commanding differential thrust from the two or more propulsors 106 located in opposing outboard locations. For example, in the illustrated embodiment, the controller can vary the motor speed of the outboard propulsor 106 on the left side of each of the forward and aft wings relative to the motor speed of the outboard propulsor 106 on the right side of each of the forward and aft wings (which changes creates a differential lifting force on the left wing tips relative to the right wing tips) to control a pitch orientation of the flight vehicle 100.

In some embodiments, the control flaps 126 can also be used to control a dynamic orientation of the flight vehicle 100. For example, command of a position of each control flap 126 can also be provided either manually by the human operator 134, automatically by the autopilot function of the controller 202, or in a combination thereof.

In addition, as noted in the “Land” column of the table 300, the controller 202 can similarly be programmed assist in maintaining stability of the flight vehicle 100 during ground operations, while accommodating human operator inputs to the throttle and manual controls 132. As noted previously, during ground operations, the manual controls 132 can control a heading of the flight vehicle 100 by steering the guidance wheels 128.

Other implementations for controlling the flight vehicle 100 in one or more degrees of freedom are also contemplated.

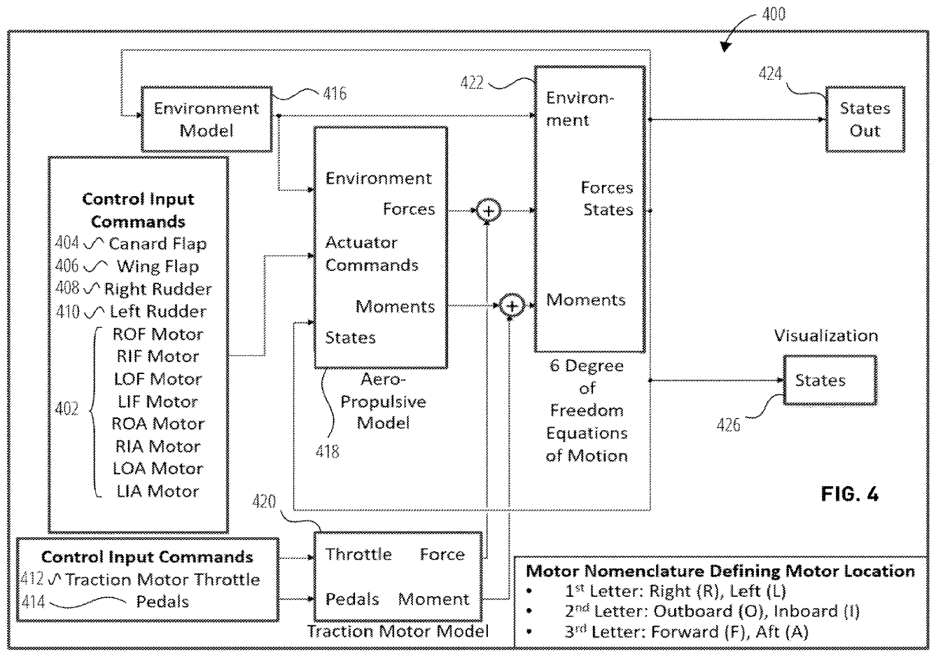

FIG. 4 illustrates an example embodiment of a controller data flow 400 that can be used by the controller 202. The controller data flow 400 can receive motor speed commands 402 corresponding to each propulsor ESC 206, including commands for the eight propulsors 106 distributed along the forward and aft wings 108 in the illustrated example, provided by the throttle, by the autopilot function of the controller 202, or by a combination thereof. The controller data flow 400 can also receive an aft flap command 404 and a forward flap command 406 corresponding to positions of the aft and forward control flaps 126, provided by the human operator 134, by the autopilot function of the controller 202, or by a combination thereof. The controller data flow 400 can further receive a right guidance wheel fairing command 408 and a left guidance wheel fairing command 410, provided by the human operator 134. These commands can be routed to an aero-propulsive model 418 which calculates resulting forces and moments on the flight vehicle 100 during flight. The forces and moments from the aero-propulsive model 418 can be routed to a flight vehicle model 422.

The controller data flow 400 can also include an environment model 416 which models an effect of atmospheric conditions (e.g., cross-winds) on the flight vehicle 100. The output of the environment model 416 can be routed to the aero-propulsive model 418 for inclusion in the calculation of aerodynamic forces and moments, and can also be routed directly to the flight vehicle model 422.

The controller data flow 400 can further receive a traction motor speed command 412 and a pedal speed command 414 provided by the human operator 134. These commands can be routed to a traction motor model 420 which calculates resulting forces and moments on the flight vehicle 100 during ground operations. The output of the traction motor model 420 can be routed to the flight vehicle model 422.

The flight vehicle model 422 can calculate, based on the various environment, force, and moment inputs, a model state output 424 including position, orientation, and rates of change thereof of the flight vehicle 100, as well as a state visualization output 426 for displaying the state to the human operator 134. The autopilot functionality of the controller 202 can use the model state output 424 to generate the next iteration of one or more of the motor speed commands 402, the aft flap command 404, or the forward flap command 406.

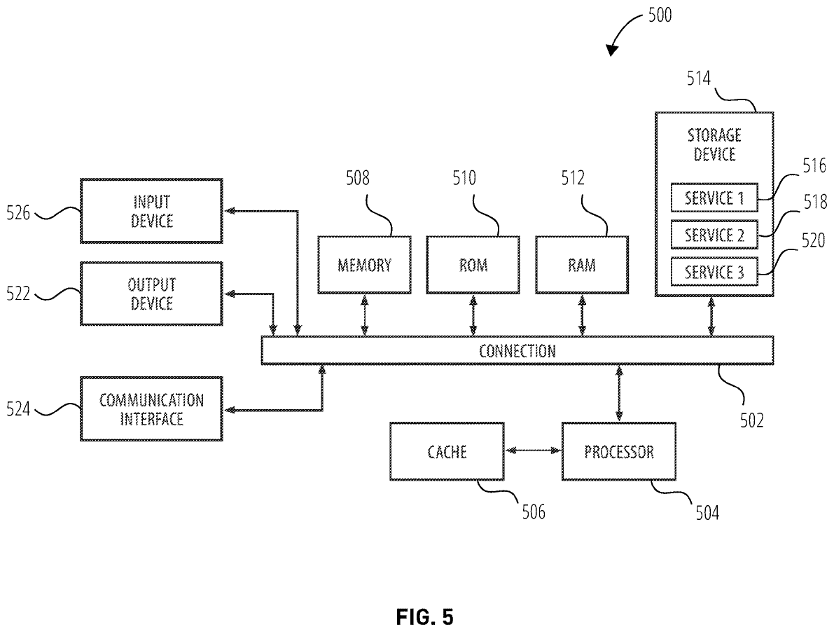

FIG. 5 illustrates an example computer device that can be used in connection with any of the systems or components of the controller 202, the avionics package 216, the traction motor ESC 204, the propulsor ESC 206, or other components disclosed herein. In this example, FIG. 5 illustrates a computing system 500 including components in electrical communication with each other using a system connection 502, such as a bus. Computing system 500 includes a processing unit (CPU or processor) 504 and a system connection 502 that couples various system components including a system memory 508, such as read only memory (ROM) 510 and random access memory (RAM) 512, to the processor 504. The computing system 500 can include a cache 506 of high-speed memory connected directly with, in close proximity to, or integrated as part of the processor 504. The computing system 500 can copy data from the memory 508 and/or a storage device 514 to the cache 506 for quick access by the processor 504. In this way, the cache 506 can provide a performance boost that avoids processor delays while waiting for data. These and other modules can control or be configured to control the processor 504 to perform various actions. Other system memory 508 may be available for use as well. The memory 508 can include multiple different types of memory with different performance characteristics. The processor 504 can include any general purpose processor and a hardware or software service, such as service 1—516, service 2—518, and service 3—520 stored in storage device 514, configured to control the processor 504, as well as a special-purpose processor where software instructions are incorporated into the actual processor design. The processor 504 may be a completely self-contained computing system, containing multiple cores or processors, a bus, memory controller, cache, etc. A multi-core processor may be symmetric or asymmetric.

To enable user interaction with the computing system 500, an input device 526 can represent any number of input mechanisms, such as a microphone for speech, a touch-sensitive screen for gesture or graphical input, keyboard, mouse, motion input, speech and so forth. An output device 522 can also be one or more of a number of output mechanisms known to those of skill in the art. In some instances, multimodal systems can enable a user to provide multiple types of input to communicate with the computing system 500. A communications communication interface 524 can generally govern and manage the user input and system output, including wireless input and output links. There is no restriction on operating on any particular hardware arrangement and therefore the basic features here may easily be substituted for improved hardware or firmware arrangements as they are developed.

Storage device 514 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 512, read only memory (ROM) 510, and hybrids thereof.

The storage device 514 can include services 516, 518, 520 for controlling the processor 504. Other hardware or software modules are contemplated. The storage device 514 can be connected to the system connection 502. In one aspect, a hardware module that performs a particular function can include the software component stored in a computer-readable medium in connection with the necessary hardware components, such as the processor 504, system connection 502, output device 522, and so forth, to carry out the function.

In some embodiments, computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

What is claimed is:

1. A flight vehicle comprising:
a frame;
a propulsion system coupled to the frame;
a first source of power coupled to the frame and configured to power the propulsion system;
a traction wheel coupled to the frame and configured for tractional engagement with a ground surface during low-speed ground operation of the flight vehicle; and
a second source of power coupled to the frame and configured to power to the traction wheel.

2. The flight vehicle of claim 1, wherein the flight vehicle weighs less than 254 pounds, has a fuel capacity not exceeding to 5 U.S. gallons, and is not capable of a level flight speed of more than 55 knots.

3. The flight vehicle of claim 1, wherein the propulsion system comprises one or more fixed-pitch propellers.

4. The flight vehicle of claim 1, wherein the second source comprises:
a pedal set coupled to the frame and configured for operation by a human operator on-board the flight vehicle to drive the traction wheel.

5. The flight vehicle of claim 1, wherein the second source comprises:
a traction motor configured to drive the traction wheel.

6. The flight vehicle of claim 5, wherein the first source comprises one or more propulsion batteries, and wherein the traction motor is further operable to charge the one or more propulsion batteries.

7. The flight vehicle of claim 5, wherein the second source comprises one or more of a traction battery or a traction capacitor configured to supply power to the traction motor.

8. The flight vehicle of claim 1, wherein the low-speed ground operation includes speeds of the flight vehicle between zero and 28 miles per hour.

9. The flight vehicle of claim 1, wherein the first source comprises one or more of propulsion batteries or solar panels.

10. The flight vehicle of claim 1, further comprising at least one wing coupled to the frame, wherein the propulsion system comprises a plurality of electrically driven propulsors distributed along the at least one wing.

11. The flight vehicle of claim 10, wherein the at least one wing comprises a forward wing and an aft wing, wherein a first set of the plurality of propulsors are distributed along the forward wing and a second set of the plurality of propulsors are distributed along the aft wing, and wherein a width of the flight vehicle does not exceed twelve feet.

12. The flight vehicle of claim 10, wherein the first source includes a plurality of propulsion batteries distributed along the at least one wing.

13. The flight vehicle of claim 10, wherein the first source includes one or more solar panels positioned on a top surface of the at least one wing.

14. The flight vehicle of claim 1, wherein the traction wheel is further configured to apply a braking force to the flight vehicle during landing of the flight vehicle.

15. The flight vehicle of claim 1, further comprising:
a guidance wheel pivotably coupled to the frame and configured to steer the flight vehicle during ground operations; and
a guidance wheel fairing coupled to the frame and at least partially enclosing, and configured to pivot with, the guidance wheel, wherein the guidance wheel fairing is operable as a control surface of the flight vehicle.

16. The flight vehicle of claim 15, wherein the guidance wheel comprises a first guidance wheel and the guidance wheel fairing comprises a first guidance wheel fairing, and wherein the flight vehicle further comprises:
a second guidance wheel pivotably coupled to the frame and configured to steer the flight vehicle during ground operations; and
a second guidance wheel fairing coupled to the frame and at least partially enclosing, and configured to pivot with, the second guidance wheel, wherein the first and second guidance wheels are positioned on opposite sides of the frame.

17. The flight vehicle of claim 16, wherein the traction wheel and the first and second guidance wheels cooperate to enable the flight vehicle to operate as a ground-based cycle on the ground surface.

18. A flight vehicle comprising:
a frame;
a propulsion system coupled to the frame;
a first source of power coupled to the frame and configured to power the propulsion system;
a guidance wheel pivotably coupled to the frame and configured to steer the flight vehicle during ground operations; and
a guidance wheel fairing coupled to the frame and at least partially enclosing, and configured to pivot with, the guidance wheel, wherein the guidance wheel fairing is operable as a control surface of the flight vehicle.

19. The flight vehicle of claim 18, wherein the guidance wheel fairing defines an airfoil profile.

20. The flight vehicle of claim 18, wherein the guidance wheel fairing comprises an independently actuatable control flap at an aft portion thereof.

21. The flight vehicle of claim 18, wherein the guidance wheel comprises a first guidance wheel and the guidance wheel fairing comprises a first guidance wheel fairing, and wherein the flight vehicle further comprises:
a second guidance wheel pivotably coupled to the frame and configured to steer the flight vehicle during ground operations; and
a second guidance wheel fairing coupled to the frame and at least partially enclosing, and configured to pivot with, the second guidance wheel, wherein the first and second guidance wheels are positioned on opposite sides of the frame.

22. The flight vehicle of claim 21, wherein the flight vehicle includes no actuatable vertical control surfaces apart from the first and second guidance wheel fairings.

23. The flight vehicle of claim 21, wherein the first and second guidance wheel fairings are further operable to induce a drag force to decelerate the flight vehicle into a controlled glide path during descent from flight towards ground.

24. The flight vehicle of claim 21, wherein the first and second guidance wheel fairings are further configured to lock in place after landing from flight.

25. The flight vehicle of claim 21, further comprising a front wheel, wherein the front wheel and the first and second guidance wheels cooperate to enable the flight vehicle to operate as a ground-based cycle on the ground surface.

26. The flight vehicle of claim 25, wherein the front wheel comprises a traction wheel configured for tractional engagement with a ground surface during a low-speed ground operation of the flight vehicle.

27. A flight vehicle comprising:
a frame;
a guidance wheel pivotably coupled to the frame;
a guidance wheel fairing at least partially enclosing the guidance wheel and configured to pivot;
at least one manual control configured to orient the guidance wheel fairing in response to operation by an on-board human operator of the flight vehicle, wherein the orientation is selectable to set a heading of the flight vehicle during flight;
a plurality of propulsors coupled to the frame; and
a controller coupled to the frame and comprising at least one processor in communication with a memory and operably coupled to the plurality of propulsors, the memory storing instructions that are executable to cause the processor to automatically maintain the flight vehicle in level flight during flight.

28. The flight vehicle of claim 27, wherein two or more of the plurality of propulsors are distributed along a span dimension of the flight vehicle, and wherein the instructions are executable to further cause the processor to automatically reduce yaw perturbations about the heading set by the manual orientation by commanding differential thrust from the two or more propulsors.

29. The flight vehicle of claim 27, wherein two or more of the plurality of propulsors are distributed along a vertical dimension of the flight vehicle, and wherein the instructions are executable to further cause the processor to automatically reduce pitch perturbations by commanding differential thrust from the two or more propulsors.

30. The flight vehicle of claim 27, wherein two or more of the plurality of propulsors are located outboard along a span dimension on opposing sides of the frame, and wherein the instructions are executable to further cause the processor to automatically reduce roll perturbations by commanding differential thrust from the two or more propulsors.
